(19) United States
(12) Patent Application Publication
(10) Pub. No.: US 2009/0150251 A1
(43) Pub. Date: Jun. 11, 2009

(54) Mobile Information Processing System

(76) Inventor: Victor Zhitomirsky, Cambridgeshire (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/992,532

(22) PCT Filed: Sep. 25, 2006
(86) PCT No.: PCT/GB2006/003552

§ 371 Date: Mar. 25, 2008

(30) Foreign Application Priority Data
Sep. 23, 2005 (GB) 0519495.6

(51) Int. Cl. G06Q 30/00

(52) U.S. Cl. 705/26

(57) ABSTRACT

A system is provided for providing mobile users with information relating to products and/or services. In one embodiment, the user has a mobile telephone having a barcode reader for reading barcodes associated with products or services. The barcode tag value obtained from reading the barcode is transmitted to a remote server via the mobile telephone network. The remote server uses the barcode value to retrieve a plurality of options associated with the product identified by the barcode value. The options are transmitted back to the user's mobile telephone where they are displayed to the user. In response to the user selecting one of the options, information relating to the selected option is retrieved and displayed to the user on the mobile telephone.

### CROSS REFERENCE TO RELATED APPLICATIONS

This application is the U.S. National Stage of International Application Number PCT/GB2006/003552 filed on Sep. 25, 2006 which was published in English on Mar. 29, 2007 under International Publication Number WO 2007/034217.

### TECHNICAL FIELD

The present invention relates to an apparatus and method for providing mobile users with information about products and/or services. The invention in particular relates to systems in which users obtain information about a product or service by, for example, reading a barcode and using the barcode value to retrieve information from a computer network such as the Internet.

### BACKGROUND OF THE INVENTION

U.S. Pat. No. 5,978,773 describes a system in which barcodes are associated with products or services and in which users can obtain information about a product or service from a remote server by reading the associated barcode using a barcode reader. More specifically, after the reader reads a barcode, a computer to which the barcode reader is attached transmits the barcode number to a pre-specified web address. The web address uses the barcode number to identify the Uniform Resource Locator (URL) of information relevant to the product or service, which the website returns to the user's computer. The user's computer then uses the returned URL to obtain the information about the product or service from the appropriate remote server via the Internet.

There are a number of problems with the system described in U.S. Pat. No. 5,978,773. The main problem is that it is relatively inflexible because it does not take into account that different users may want to know different information about the product or service being offered. For example, some users may want to know about environmental information relating to the product or service whilst other users may want to know about ingredients or recommended recipes in which the product can be used.

### SUMMARY OF THE INVENTION

Embodiments of the present invention were made on the foregoing in mind, and an embodiment aims to address this problem by providing a system that can provide information concerning a product or service that is tailored for each user.

According to one aspect, the present invention provides a system: (i) in which a user uses a mobile device to read a machine readable code that is associated with a product or service, to generate a tag value; (ii) in which the tag value is transmitted to a remote server, which uses the tag value to retrieve a plurality of options associated with the tag value which the server returns to the user's mobile device; (iii) in which the user's mobile device includes stored profile data for the user; and (iv) in which the user's mobile device uses the stored profile data to select an option or to rank the plurality of options received from the remote server for output to the user. With this arrangement, different types of options can be offered to the user's mobile device and the user can then select the option they require or the mobile device can automatically select the option based on the stored user profile. The system therefore allows the user to obtain, suitably in an efficient manner, information (such as multimedia content) that will be relevant to the user. The information that is obtained may be related to the product or service associated with the machine readable code or it may be unrelated and provided, for example, as a reward for purchasing a product or service.

The mobile device can be any portable computer device such as a mobile or cellular telephone, a personal digital assistant or the like. The machine readable code may be carried by an electronic transponder such as an RFID tag that is associated with (for example, physically attached to) the product or service. However, in a particular embodiment, the machine readable code is carried by an optical barcode that is printed on a substrate that is associated with the product or service. For example, the barcode may be printed on a label attached to the product or it may be printed in a magazine or newspaper advert for the product or service.

According to another aspect, the present invention provides a system: (i) in which a user uses a mobile device to read a machine readable code that is associated with a product or service, to generate a tag value; (ii) in which the user's mobile device transmits user profile data together with the tag value to a remote server; (iii) in which the remote server uses the user profile data and the tag value to make a selection of options from a number of stored options, which the remote server returns to the user's mobile device; (iv) in which the mobile device outputs the selected options to the user; (v) in which the user selects an option and the mobile device transmits data identifying the selected option to the remote server; and (vi) in which the remote server uses the selected option to identify information relevant to the chosen option to be sent to the user's mobile device. With this arrangement, the remote server can make a more targeted selection of options that will be relevant to each user.

In one embodiment of this system, the remote server analyzes the selected options, user profiles and tag values made by a plurality of users and updates the databases from which it selects the options from the stored options for a received tag value and user profile. In this way, the remote server will adapt to changing user patterns.

In another embodiment of this system, the remote server analyzes the selected options, user profiles and tag values made by a plurality of users and generates an update for a profile calculator stored on the user's portable device that is used to generate the user profile. In this way, the way in which the user's mobile device generates the user profile data will be adapted depending on the usage patterns of other users.

According to another aspect, the invention provides a system: (i) in which a user uses a mobile device to read a machine readable code that is associated with a product or service to generate a tag value; (ii) in which the tag value is transmitted to a remote server, which uses the tag value to retrieve a plurality of options associated with the tag value which the server returns to the user's mobile device; (iii) in which the user's mobile device outputs one or more of the received options to the user for user selection; (iv) in which the user selects an option and the mobile device transmits data identifying the selected option to the remote server together with stored user profile data; (v) in which the remote server uses the selected option, the tag value and the user profile data to generate an update for a user profile calculator; (vi) in which the user's mobile device uses the selected option and the tag value to update its internal user profile using a profile calculator; and (vii) in which the profile calculator in the user mobile device is periodically updated by the remote server.

According to a further aspect, the invention provides a system: (i) in which a user uses a mobile device to read a machine readable code that is associated with a product or service to generate a tag value; (ii) in which the mobile device stores content associated with a tag value; (iii) in which the mobile device determines if the generated tag value is associated with content stored in the mobile device; (iv) in which the mobile device outputs the content to the user if it determines that the generated tag value is associated with content stored in the mobile device; (v) in which the mobile device transmits the generated tag value to a remote computer server if it determines that the generated tag value is not associated with content stored in the mobile device; and (vi) in which the remote server uses the tag value to retrieve information relevant to the product or service associated with the generated tag value which it transmits to the mobile device.

These and other aspects of the invention will become apparent from the following detailed description of embodiments, provided by way of example only, in which:

### BRIEF DESCRIPTION OF THE DRAWINGS

FIG. 1 is a schematic diagram illustrating a system in which a user mobile telephone includes a barcode reader for reading barcodes associated with products or services and in which information relating to the products or services can be obtained by the user's mobile telephone from a remote server via the telephone network and the Internet;

FIG. 2 is a timeline illustrating the information exchange between the user's mobile telephone, the mobile portal and the merchant website shown in FIG. 1;

FIG. 3 is schematic block diagram illustrating the main components of the user's mobile telephone shown in FIG. 1;

FIG. 4a schematically illustrates the form of a tag value table stored in a tag database forming part of the mobile portal shown in FIG. 1;

FIG. 4b schematically illustrates the form of an options text table stored in the tag database shown in FIG. 1;

FIG. 4c schematically illustrates the form of the data stored in an options database forming part of the mobile portal shown in FIG. 1;

FIG. 5 is a timeline illustrating the communications between the user's mobile telephone, the mobile portal and the merchant website in a second embodiment;

FIG. 6a schematically illustrates the main components of a user's mobile telephone used in the second embodiment in which the user's mobile telephone updates internally stored user profile data using a profile calculator;

FIG. 6b schematically illustrates the form of the user profile data which is stored within the user's mobile telephone shown in FIG. 6a;

FIG. 7 schematically illustrates the main processing modules of the mobile portal server used in the second embodiment;

FIG. 8a schematically illustrates the form of the tag value tables stored in the tag database of the mobile portal in the second embodiment;

FIG. 8b illustrates the form of the data stored in the options database of the mobile portal in the second embodiment;

FIG. 9 schematically illustrates an alternative system according to a third embodiment in which the mobile portal includes a content database for storing content that can be downloaded to a user's mobile telephone;

FIG. 10 is a block diagram illustrating the main components of the user's mobile telephone used in the third embodiment;

FIG. 11a is a flow chart illustrating a first part of the processing steps performed by the user's mobile telephone in the third embodiment; and

FIG. 11b is a flow chart illustrating a second part of the processing steps performed by the user's mobile telephone in the third embodiment.

### DETAILED DESCRIPTION

### First Embodiment

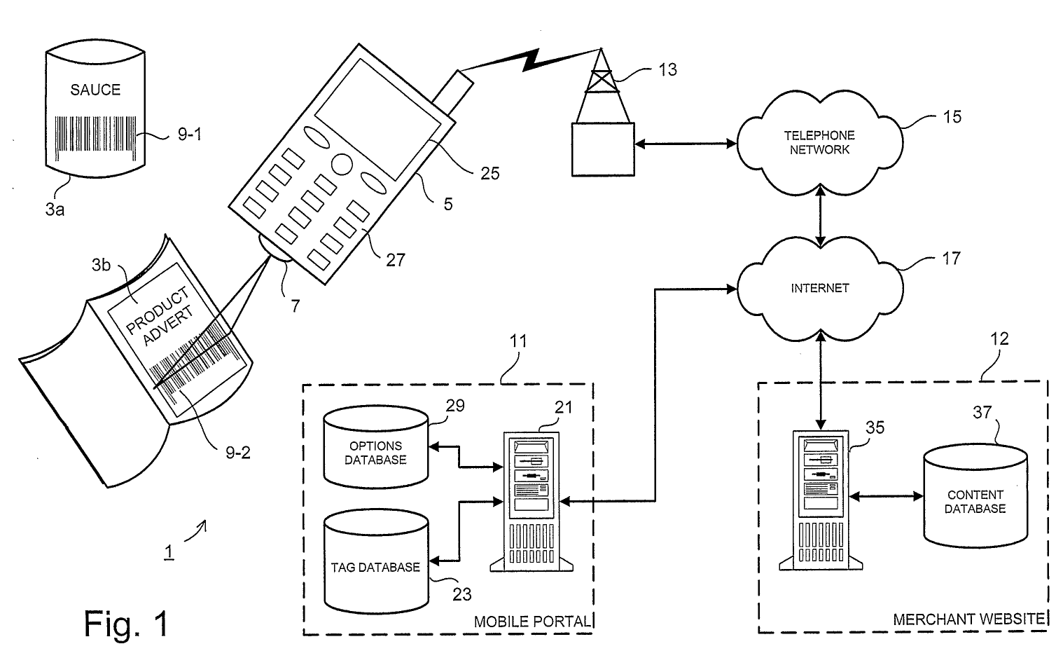

Overview FIG. 1 is a schematic diagram illustrating the components of a system 1 that allows users to obtain information about products 3 or services offered by merchants. As shown, the system 1 includes a user mobile telephone (i.e. a cellular telephone) 5 having a barcode reader 7 for reading barcodes 9-1, 9-2 printed on products 3a or associated with a product advert 3b printed in, for example, magazines, newspapers or the like. The system further includes a mobile portal 11 and a merchant website 12, both of which can communicate with the user's mobile telephone 5 via a mobile telephone base station 13, the telephone network 15 and the Internet 17.

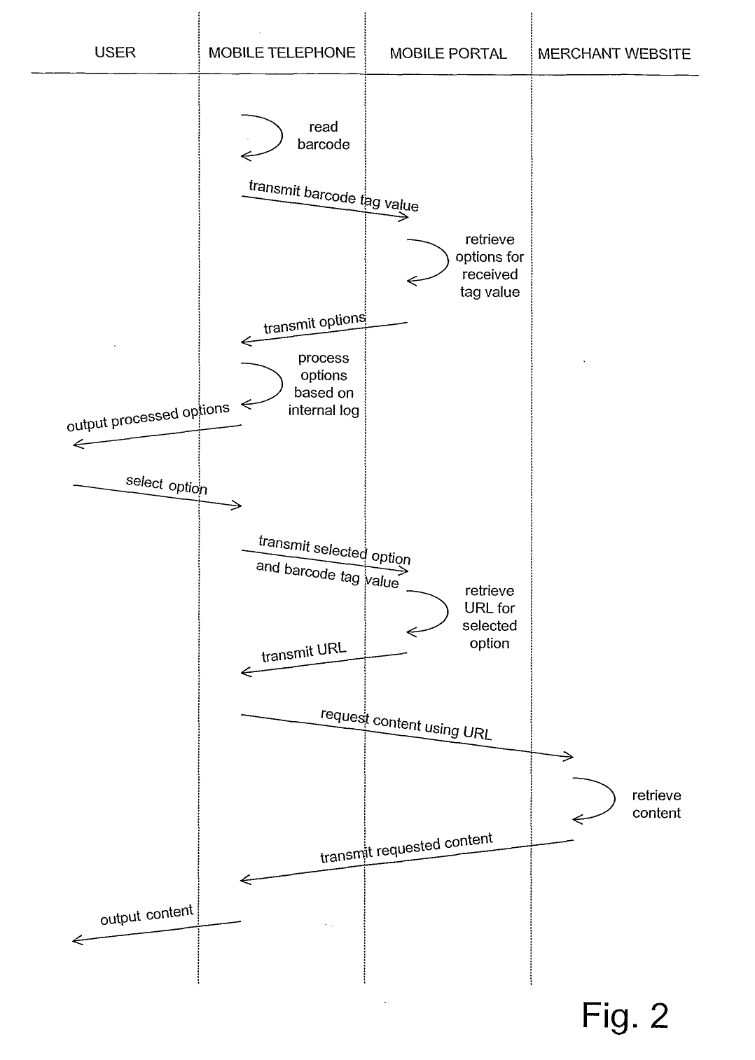

The operation of the system 1 shown in FIG. 1 will now be described with reference to FIG. 2. Initially, the user reads a barcode 9 associated with a product 3 using the barcode reader 7 formed integrally with the user's mobile telephone 5. The barcode tag value output by the barcode reader 7 is then transmitted by the mobile telephone 5 to the mobile portal 11 via the mobile network base station 13, the telephone network 15 and the Internet 17.

A computer server 21 within the mobile portal 11 uses the barcode tag value to address a tag database 23 which stores a plurality of options associated with the different tag values. For example, where the barcode is associated with a foodstuff, such as a sauce, the options might include ingredients, country of origin, suggested recipes, etc. If the barcode is associated with an advert for a product such as motor car, then the options may include details of the manufacturer, details of additional extras that can be added to the basic model, road test reports, petrol consumption figures, environmental gas emissions etc. The mobile portal server 21 then transmits the retrieved options back to the user's mobile telephone 5 via the Internet 17, the telephone network 15 and the base station 13.

In this embodiment, the mobile telephone 5 stores an internal log of options that the user has selected on previous occasions, which the mobile telephone 5 uses to rank the options received from the mobile portal 11. In particular, the mobile telephone 5 uses the internal log to identify the options that the user is most likely to select. The mobile telephone 5 then outputs the ranked options to the user. In this embodiment, the options are output via the display 25 of the mobile telephone 5. The user can then scroll through the list of ranked options and select one of the options using the keypad 27 of the mobile telephone 5. The mobile telephone 5 then transmits the selected option together with the barcode tag value back to the mobile portal 11 via the base station 13, the telephone network 15 and the Internet 17.

In response, the mobile portal server 21 uses the selected option and the barcode tag value to address an options database 29 which stores, for each option and each barcode tag value, a Uniform Resource Locator (URL) where information can be obtained relating to the selected option for that barcode tag value. The mobile portal server 21 returns the URL for the selected option back to the user's mobile telephone 5. In response, the mobile telephone 5 uses the received URL to request the content from a merchant website 12 corresponding to the URL, via the base station 13, the telephone network 15 and the Internet 17. A computer server 35 within the merchant website 12 receives the request and retrieves the requested content from a content database 37. The merchant server 35 then returns the requested content back to the user's mobile telephone 5 via the Internet 17, the telephone network 15 and the base station 13. The mobile telephone 5 then outputs the received content, in this embodiment, via the display 25.

As those skilled in the art will appreciate, with the above arrangement, the user is able to gain access to different types of information relating to a product or service through the reading of a single barcode associated with the product or service.

A more detailed description of the user's mobile telephone 5 and of the mobile portal 11 used in this embodiment will now be given.

### Mobile Telephone

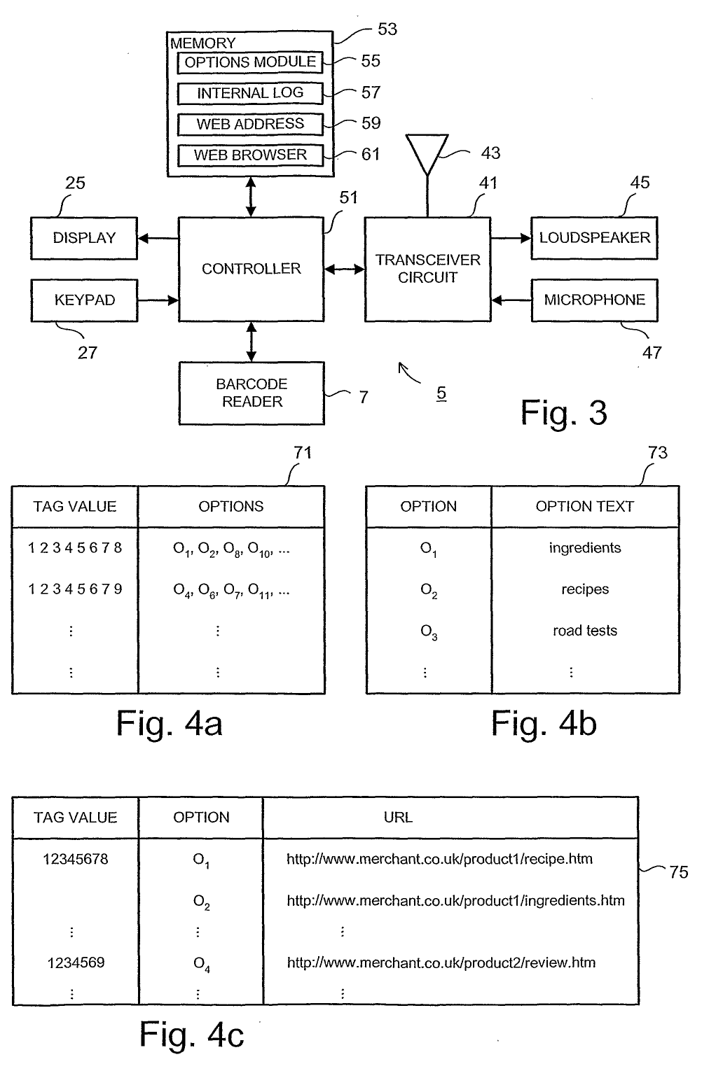

FIG. 3 is a block diagram illustrating in more detail the main components of the user's mobile telephone 5 used in this embodiment. As shown, the mobile telephone 5 includes a transceiver circuit 41 and an antenna 43 for transmitting signals to and for receiving signals from the mobile telephone base station 13. The mobile telephone 5 also includes a loudspeaker 45 and a microphone 47 which are both connected to the transceiver circuit 41 so that the user can make and receive telephone calls in the usual way.

As shown in FIG. 3, the mobile telephone 5 also includes a controller 51 which controls the operation of the mobile telephone 5 under control of various software modules stored within memory 53. In this embodiment, the memory 53 stores an options module 55, the above described internal log 57, the web address 59 for the mobile portal 11 and a web browser 61. The controller 51 is connected to the transceiver circuit 41 which allows the web browser 61 to transmit information to and to receive information from remote servers via the base station 13, the telephone network 15 and the Internet 17.

FIG. 3 also shows the barcode reader 7 which forms part of the mobile telephone 5 and which is used to read the barcodes associated with products or services. In this embodiment, the barcode reader 7 is normally powered down to save battery power. Therefore, in this embodiment, when the user wishes to read a barcode, they must press an appropriate button on the keypad 27 to cause the controller 51 to power up the barcode reader 7. The barcode reader 7 then reads the barcode associated with the product and generates a barcode tag value which it passes to the controller 51. In response, the controller 51 initiates the web browser module 61 which transmits the barcode tag value to the mobile portal 11 using the web address 59 stored in memory 53.

When the options associated with the barcode are received back from the mobile portal 11, the controller 51 initiates the options module 55 which uses the internal log 57 to process the options to generate a ranked list of options, with those options that the user is most likely to want appearing higher in the list than those options which the user is less likely to want. The options module 55 then passes the ranked list of options to the web browser 61 for output to the user via the display 25. The web browser 61 provides the functionality that allows the user to scroll through the displayed options and to select one of the options via the keypad 27. In response, the web browser 61 informs the options module 55 of the selected option (so that it can update the internal log 57) and transmits the selected option together with the barcode tag value back to the mobile portal 11 using the web address 59. When the URL for the content associated with the selected option is returned from the mobile portal 11, the web browser 61 automatically uses the URL to request the content from the appropriate merchant website 12. When the requested content is received, the web browser 61 outputs the content to the user via the display 25.

As will be apparent from the above description, the options module 55 is responsible for processing the options received from the mobile portal 11 to rank the options and is responsible to update the internal log 57.

As those skilled in the art will appreciate, there are various ways in which the options module 55 can perform these functions. However, the specific way in which these functions are performed in this embodiment will now be described.

In this embodiment, when the mobile portal 11 returns the options associated with the read barcode tag value, each option includes an option identifier and text associated with the option. The web browser 61 uses the text to display the option on the display 25. However, when one of the options is selected by the user, the option identifier for the selected option is passed from the web browser 61 to the options module 55. In this embodiment, the internal log comprises a set of counts that is maintained for all the options that the user has previously selected. In particular, each time a user selects an option, a count associated with that option is incremented within the internal log 57. If this is the first time that the option has been selected, then a new count associated with the option identifier is created in the internal log 57.

When ranking the options received from the mobile portal 11, the options module 55 compares the received option identifiers with the counts stored in the internal log 57. The option module then ranks the received options so that the options having the highest associated counts in the internal log 57 are ranked higher than other options having lower counts or no count at all. If none of the received options has a count in the internal log 57, then the options are ranked equally and the options are output to the user in the order they are received from the mobile portal 11. In this way, the more the user uses the system, the more accurately the internal log 57 will be able to identify the options the user is most likely to select.

### Mobile Portal

As mentioned above, the mobile portal 11 includes a computer server 21 which is operable to communicate with user devices, such as the mobile telephone 5. As those skilled in the art will appreciate, the mobile portal server 21 will include one or more central processing units (CPUs), memory and the appropriate network communications software and hardware that allow it to communicate via the Internet 17 and the telephone network 15. The mobile portal server 21 will also include or have access to large capacity storage, such as a hard disk, for storing the tag database 23 and the options database 29.

FIGS. 4a and 4b schematically illustrate the form of the data stored within the tag database 23 in this embodiment. As shown, the tag database 23 stores two sets of data. The first data set 71 is a tag value table which stores all the different possible barcode tag values together with an identifier for each option that is associated with that barcode value. In particular, each barcode tag value is associated with a sub-set of all possible options. This is because not all options will be appropriate for all products. For example, a road test option will not be appropriate for groceries that are sold in a supermarket. As shown in the tag value table 71, the options are identified by an option identifier, Oᵢ, which is an index into the second data set 73 which is an options text table. As shown in FIG. 4b, the options text table 73 includes the different option identifiers, Oᵢ, together with the corresponding text for the option.

In operation, when the mobile portal server 21 receives the barcode tag value from the user's mobile telephone 5, it uses the barcode tag value to address the tag value table 71 shown in FIG. 4a, to determine the option identifiers associated therewith: i.e. O₁, O₂, O₈, O₁₀ . . . for barcode value 12345678. The mobile portal server 21 then uses each of these option identifiers to address the options text table 73, to retrieve the text associated with each of those options. The Mobile portal server 21 then transmits the option identifiers together with the corresponding text back to the user's mobile telephone 5.

As discussed above, when the mobile portal server 21 receives the selected option identifier and the barcode tag value back from the user's mobile telephone 5, the server 21 uses the returned data to address the options database 29. FIG. 4c illustrates the form of the data 75 stored within the options database 29. As shown, the data 75 includes all of the barcode tag values, the option identifiers (Oᵢ) associated with each barcode tag value and the corresponding URL for each option. The mobile portal server 21 then returns the URL corresponding to the selected option for the barcode tag value back to the user's mobile telephone 5.

### Second Embodiment

### Overview

In the above embodiment, the user's mobile telephone 5 maintained an internal log 57 recording the history of options previously selected by the user. This log was used to control the order in which received options were output to the user via the display 25 of the mobile telephone 5. In this way, the system of the first embodiment takes into account previous selections made by the user to identify relevant information about a product or service as quickly as possible and with minimum user interaction. A second embodiment will now be described in which the system takes into account the selections made by similar users when selecting options to be sent to a user device.

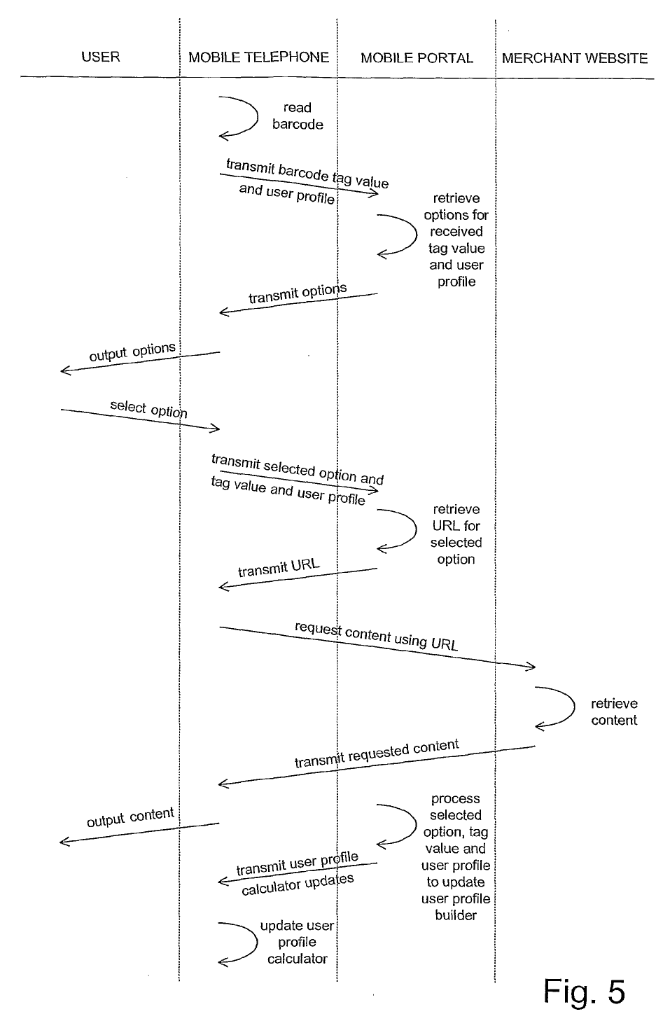

The system architecture used in this embodiment is the same as illustrated in FIG. 1 and will not therefore be described again. An overview of the operation of the second embodiment will now be given with reference to FIG. 1 and FIG. 5, which is a flow chart illustrating the communications between the mobile telephone 5, the mobile portal 11 and the merchant website 12.

As shown, initially the user reads a barcode 9 associated with a product 3 (or service) using the barcode reader 7. The barcode tag value output by the barcode reader 7 is then transmitted together with a user profile stored internally within the mobile telephone 5 to the mobile portal 11. In response, the mobile portal server 21 uses the received user profile to categorise the user associated with the mobile telephone 5 into one of a plurality of user types. The mobile portal 11 then uses the barcode tag value to retrieve options specific to that type of user from the tag database 23. In this way, (compared to the first embodiment) a more targeted set of options are retrieved from the tag database 23 and transmitted back to the user's mobile telephone 5.

In this embodiment, when the mobile telephone 5 receives the options from the mobile portal 11, it does not process the options based on the internal log 57. Instead, it simply outputs the options to the user via the display 25. Once the user selects one of the displayed options, the mobile telephone 5 transmits the selected option together with the barcode tag value and the user profile back to the mobile portal 11. As in the first embodiment, the mobile portal 21 uses the selected option and the barcode tag value to retrieve the associated URL, which it returns to the user's mobile telephone 5. In response, the user's mobile telephone 5 retrieves and displays the content in the same way as in the first embodiment described above.

In this embodiment, when the mobile portal 21 receives the details of the selected option, the barcode tag value and the user profile from the user's mobile telephone 5, it performs a statistical analysis on similar data obtained from other users to update the user profile types and the databases 23 and 29 stored within the mobile portal 11. Alternatively or in addition, the mobile portal server 21 also generates from time to time updates for a user profile calculator which is used by the user's mobile telephone 5 to calculate and maintain the user profile stored in the user's mobile telephone 5. When an update is generated, the mobile portal 11 transmits it to the user's mobile telephone 5 which uses it to update the user profile calculator that is stored in the user's telephone 5. In this way, the system adapts as more information becomes available from user selections which allows the system to predict more accurately the type of options that each type of user is likely to want, thereby leading to a more user friendly and useful system.

A more detailed description of the user's mobile telephone 5 and the mobile portal 11 used in this embodiment will now be given.

### Mobile Telephone

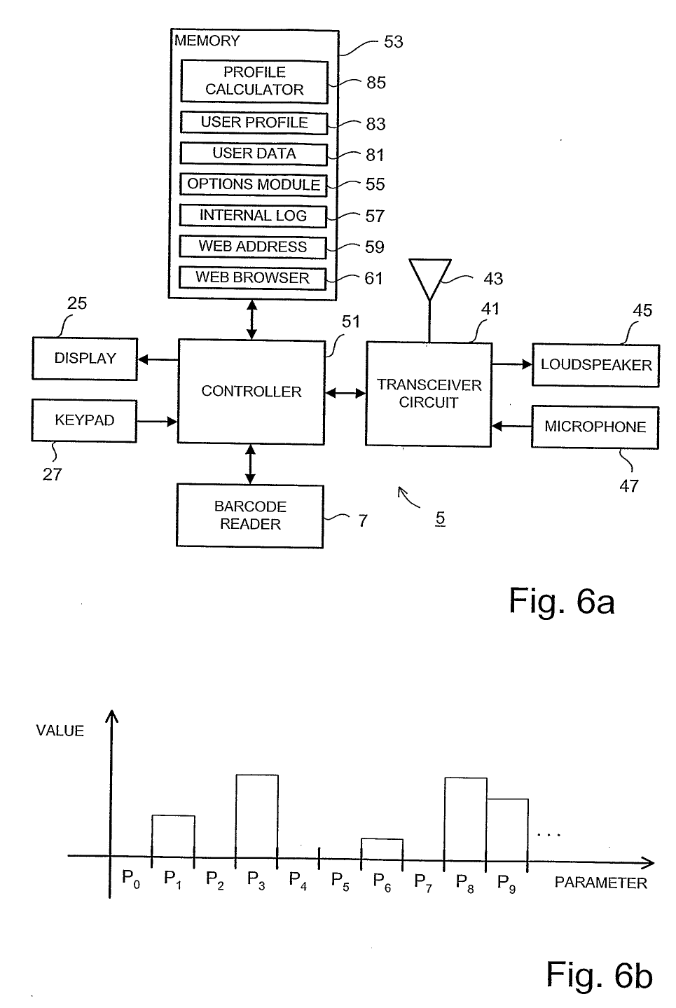

FIG. 6a is a block diagram illustrating the main components of the user's mobile telephone 5 used in this embodiment. The same reference numerals have been used to designate the same or similar components of the mobile telephone 5 shown in FIG. 3. As shown, in this embodiment, the mobile telephone 5 includes user data 81, user profile data 83 and a profile calculator 85. The user data 81 stores personal information entered by the user such as the user's sex, race, nationality, current address, education level, family status, profession, level of income, hobbies, level of involvement with new technologies (i.e. technophile or technophobe) etc. The user profile 83 is a set of generalised data representative of the user data 81 and the data stored in the internal log 57. In this embodiment, the internal log 57 has a different format to the internal log 57 used in the first embodiment. In particular, in this embodiment, the internal log 57 comprises the barcode tag value for previous barcodes that have been read together with the option identifier selected by the user for that barcode tag value.

In this embodiment, the user profile data 83 comprises a set of parameter values that are obtained by processing the information stored in the user data 81 and the internal log 57. The form of the user profile data 83 used in this embodiment is graphically shown in FIG. 6b. As shown, the user profile data 83 comprises a plurality of parameters (pᵢ) whose values are determined from predetermined formulas and/or algorithms defined in the profile calculator 85 shown in FIG. 6a. In particular, the profile calculator 85 defines a set of formulas and/or algorithms that each relates selected data from the user data 81 and the internal log 57 to the value associated with a particular parameter. As is well known to those skilled in the art of user profiling, there are various formulas and algorithms that can be employed by the profile calculator 85 to calculate the parameter values of the user profile data 83. For more details of the type of user profiling that may be performed, the reader is referred to the papers entitled “Web Usage Analysis and User Profiling” Springer Verlag—Lecture Notes in Computer Science for the International WebKDD'99 Workshop San Diego and “Enhancing 3G Cellular Systems with User Profiling Techniques for Multimedia application QoS adaptation” by Araniti et al, Springer Verlag—Lecture Notes in Computer Science for the International Conference on Telecommunications, Fortaleza, Brazil 2004.

One of the advantages of this embodiment is that the detailed personal information about the user contained within the user data 81 is not transmitted to the mobile portal 11. Only the generalised user profile data 83 derived from the user data 81 and the internal log 57 is sent to the mobile portal 11. This is advantageous as it allows detailed user profiling to be carried out whilst maintaining user anonymity.

As described above, from time to time, the mobile portal server 21 will transmit updates for the user profile calculator 85. This allows the formulas and algorithms used by the user profile calculator 85 to be updated in order to provide better user profiling within the user's mobile telephone 5.

### Mobile Portal

FIG. 7 is a block diagram illustrating the main components of the mobile portal server 21 used in this embodiment. As shown, the mobile portal server 21 includes a portal controller 91 which controls the operation of the mobile portal server 21. In particular, the portal controller 91 receives the barcode tag value and the user profile data 83 transmitted from the user's mobile telephone 5 and makes appropriate queries to the tag database 23 to retrieve appropriate options to be returned to the user's mobile telephone 5. The portal controller 91 also receives the subsequent selected option and the barcode tag value from the user's-mobile telephone 5 which it uses to access the options database 29 to retrieve the URL associated with the selected option and barcode tag value.

As shown in FIG. 7, the mobile portal server 21 also includes a user profile processing module 93 which processes the user profile data 83 received from the user's mobile telephone 5 to categorise the user as belonging to one of N different user types. The user profile processing module 93 returns the determined user type (UTᵢ) to the portal controller 91 which uses the user type and the received barcode tag value to retrieve the options associated therewith from the tag database 23.

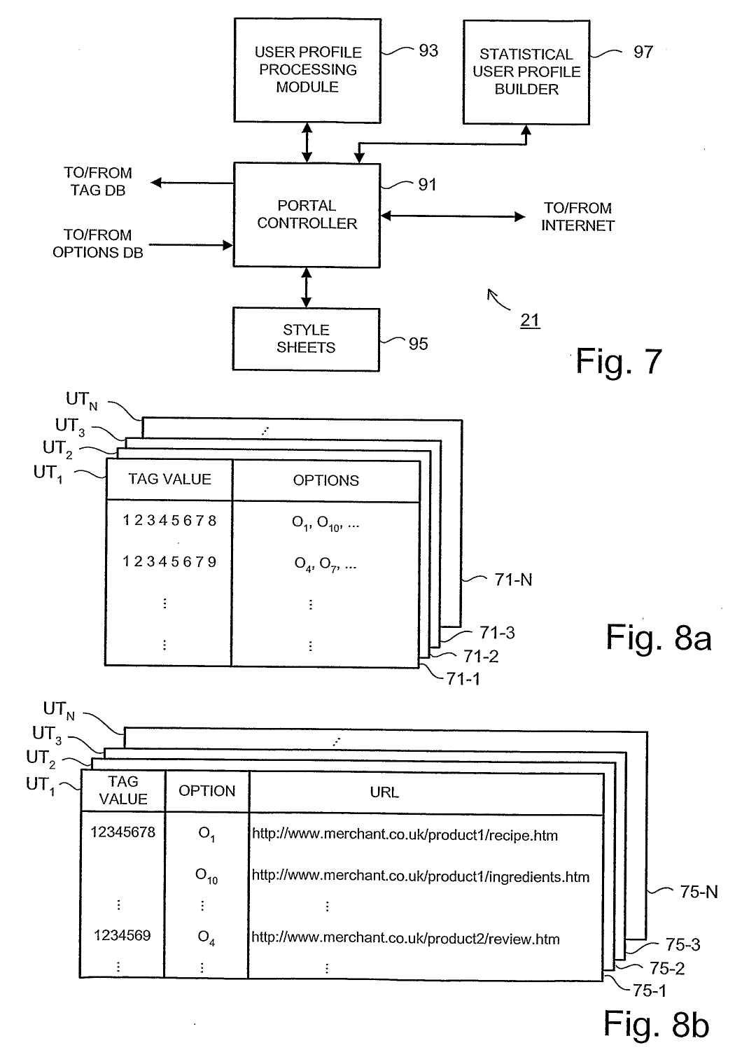

In this embodiment, the tag value table 71 within the tag database 23 is divided into N tag value tables, one for each of the different user types. This is illustrated in FIG. 8a which shows the N tag value tables 71-1 to 71-N. Each tag value table 71-j stores the option identifiers that are targeted for the corresponding type of user. For example, as shown in FIG. 8a, the option identifiers stored for the barcode tag value 12345678 for user type UT₁ include options O₁, O₁₀ . . . , which is the subset of the option identifiers shown in FIG. 4a (for the same barcode value) which the mobile portal 11 predicts is most likely to appeal to users who belong to user type UT₁.

In operation, when the portal controller 91 receives the determined user type (UTⱼ) from the user profile processing module 93, it uses this information to select the corresponding tag value table 71-j within the tag database 23. The portal controller 91 then uses the received barcode tag value to retrieve the option identifiers associated with that barcode tag value from the selected tag value table 71-j. The portal controller 91 then uses the retrieved option identifiers to retrieve the corresponding text for each option from the options text table 73 which has the same format as the options text table shown in FIG. 4b.

In this embodiment, when the portal controller 91 returns the option identifiers and the text for each option to the user's mobile telephone 5, the portal controller 91 generates a specific layout of web page for the particular type of user. In particular, in this embodiment, the mobile portal server 21 includes a set of style sheets 95 each associated with a subset of the N different user types. Additionally, in this embodiment, as the options stored in the tag database 23 are stored based on user profile information, the options associated with each barcode tag value are ranked for likely relevance based on the user profile information. In this embodiment, this ranking is performed in advance and the option identifiers are stored within the tag value tables 71 in the ranked order. In this way, the style sheets 95 can present the most likely options to the user in a layout and manner that makes it easy for the user to select the desired option. The way in which the portal controller 91 uses such style sheets 95 to personalise the options that are returned is well known to those skilled in the art and will not be described further here.

As discussed above, when the user selects one of the options, the user's mobile telephone 5 transmits the option identifier for the selected option together with the user profile data 83 and the barcode tag value back to the mobile portal 11. The portal controller 91 uses the received option identifier and barcode tag value to retrieve the appropriate URL from the options database 29. In this embodiment, the data 75 stored within the options database 29 is also divided into separate sets of data for the N different types of users. This is schematically illustrated in FIG. 8b, which shows the N data sets 75-1 to 75-N. In this way, further targeting of the content for the different users can be achieved as different URL's for the different user types for the same options are stored within the options database 29.

When the portal controller 91 receives the selected option together with the barcode tag value and the user profile data 83, it passes this information to a statistical user profile builder 97. The statistical user profile builder 97 processes similar data from all the different users of the system, to determine correlations between the user profile data 83, the products identified by the barcode tag values and the selected options. The statistical user profile builder 97 then uses the determined correlations to update the algorithms used by the user profile processing module 93 and to update the tag value tables 71 stored within the tag database 23 and/or the tables 75 stored in the options database 29. In this embodiment, the statistical user profile builder 97 also uses the determined correlations to determine better and more accurate algorithms and formulas to be used by the profile calculator 85 within the user's mobile telephone 5, to calculate the user profile data 83 from the stored user data 81 and the internal log 57. These updates are then passed to the portal controller 91 for transmission back to the user's mobile telephone 5.

As will be apparent to those skilled in the art, with the above arrangement, the system of the second embodiment will dynamically adapt to increased knowledge of the different user types and to changing user patterns.

### Third Embodiment

### Overview

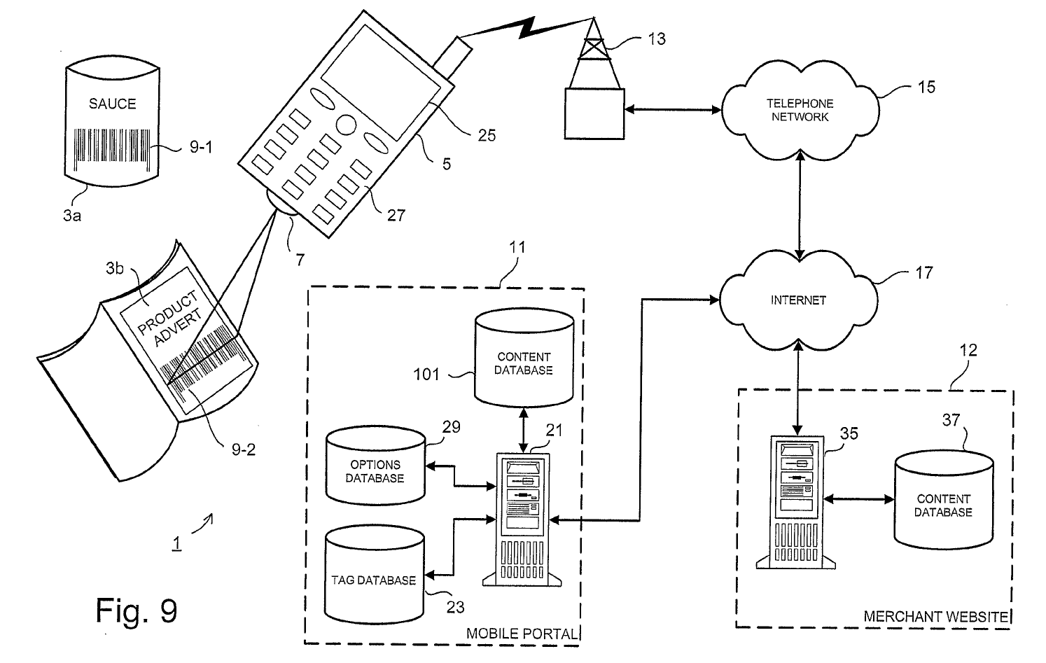

In the second embodiment described above, the user's mobile telephone 5 generated user profile data 83 from user data 81 provided by the user and an internal log 57 of previous barcodes that had been read and subsequent options selected. A third embodiment will now be described which is based on the second embodiment but in which the mobile portal 11 stores additional content (within a content database 101, shown in FIG. 9) that is downloaded and stored in the user's mobile telephone 5, for subsequent output to the user in the event that the user reads a barcode associated with the downloaded content.

More specifically, in this embodiment, the mobile portal 11 uses the user profile data 83, the barcode tag value and the selected option to predict other products that the user is likely to be interested in, using its knowledge of the activities of other similar users. For example, from the behaviour of other users, the mobile portal server 21 can determine that users of a particular type after reading a barcode associated with a particular product often subsequently read the barcode of a related product. Therefore, in this embodiment, the mobile portal server 21 uses this knowledge to download content for the related product for storage in the user's mobile telephone 5. As those skilled in the art will appreciate, this arrangement offers the advantage that if the user does subsequently read the barcode of the related product, then the content for that product is already stored in the user's device and therefore delays caused by downloading the content over the Internet 17 and the telephone network 15 are avoided.

A more detailed description will now be given of the operation of the user's mobile telephone 5 used in this embodiment.

### Mobile Telephone

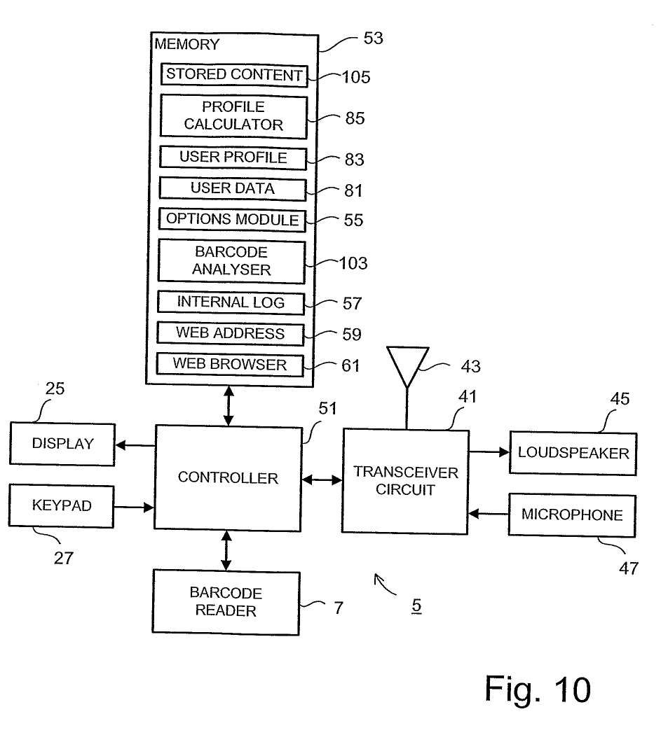

FIG. 10 is a block diagram illustrating the main components of the user's mobile telephone 5 used in this embodiment. As can be seen from a comparison of FIG. 10 with FIG. 6a, the main difference between the mobile telephone 5 of this embodiment and the mobile telephone of the second embodiment is the provision of a barcode analyser 103 and stored content 105. The stored content 105 is content that has been previously received from the mobile-portal 11 together with its associated barcode tag value.

The barcode analyser 103 is provided to analyse the barcode tag value output by the barcode reader 7. In particular, the barcode analyser 103 determines whether or not the barcode tag value received from the barcode reader 7 corresponds to any of the stored content 105. If it does, then the bar code analyser 103 passes the stored content to the web browser 61 for output to the user on the display 25. If the barcode tag value received from the barcode reader 7 does not correspond to any of the stored content 105, then the barcode analyser 103 passes the barcode tag value to the web browser 61 for transmission to the remote mobile portal 11 as in the second embodiment.

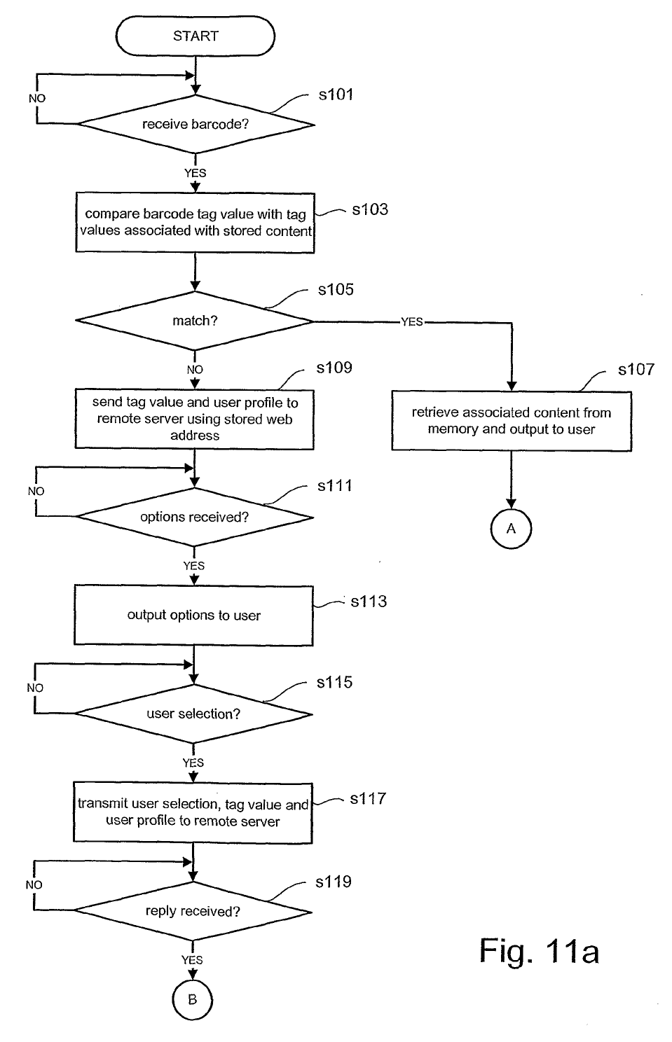

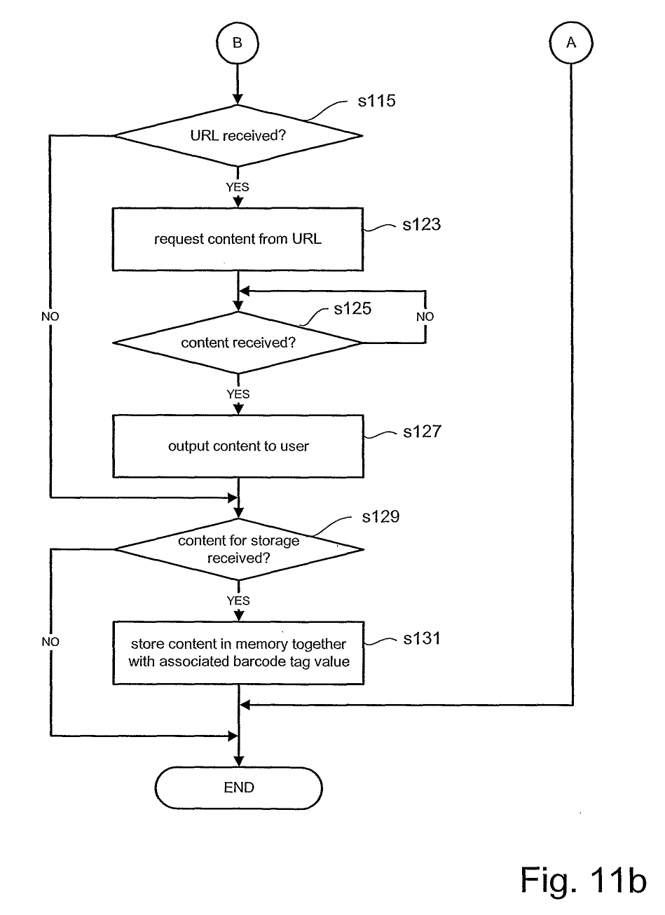

A more detailed description of the operation of the user's mobile telephone 5 will now be given with reference to the flow chart shown in FIGS. 11a and 11b. As shown, the processing starts at step s101 where the controller 51 determines whether or not a barcode has been received from the barcode reader 7. If it has, then processing proceeds to step s103 where the controller 51 passes the barcode tag value to the barcode analyser 103 which compares the barcode tag value with any barcode tag values in the stored content 105. In step s105 the bar code analyser 103 determines whether or not there is a match between the compared barcode tag values. If there is, then the processing proceeds to step s107 where the barcode analyser 103 retrieves the content from the memory 105 and passes it to the web browser 61 for output to the user. The processing then ends.

If, on the other hand, the received barcode tag value does not match any of the barcode tag values in the stored content 105 then, in step s109, the barcode analyser 103 passes the received barcode tag value to the web browser 61 which sends the barcode tag value and the user profile data 83 to the mobile portal server 21 (using the web address 59). The mobile telephone 5 then waits in step sill for the remote mobile portal server 21 to return the options associated with the transmitted barcode tag value. Once the options have been received, the processing proceeds to step s113 where the web browser 61 outputs the options to the user on the display 25. The processing then proceeds to step S115 where the web browser 61 waits for the user to make a selection from the displayed options. Once an option has been selected, the web browser 61 transmits, in step s117, the selected option together with the barcode tag value and the user profile data 83 to the mobile portal server 21. The web browser 61 then waits in step S119 for a reply from the mobile portal server 21. Once a reply has been received, the web browser 61 determines in step S121 whether or not the reply is a URL. If it is, then the web browser 61 requests, in step s123, the content from the remote merchant website 12 using the received URL. The web browser 61 then waits, in step s125 for the requested content to be returned from the remote merchant website 12. Once the content is received, the web browser 61 outputs the content to the user on the display 25 in step s127.

After step s127 or if at step s115 the web browser 61 determines that a URL has not been received, the processing proceeds to step s129 where the web browser 61 determines whether or not the reply from the mobile portal 11 corresponds to content for storage. If it does, then the processing proceeds to step s131, where the web browser 61 stores the received content together with the associated barcode tag value in the memory 53 of the mobile telephone 5. The processing then ends.

### MODIFICATIONS AND ALTERNATIVE EMBODIMENTS

Three embodiments have been described above which allow a user to obtain information about products or services by reading a barcode associated with the product or service. A number of modifications and alternatives to the above embodiments will now be described.

In the first embodiment, the user's mobile telephone 5 processed the options received from the mobile portal server 21 to rank the options based on an internal log maintained for previous options selected by the user. As those skilled in the art will appreciate, it is not essential for the user's mobile telephone to rank the options. In an alternative embodiment, the mobile telephone 5 may use the stored internal log 57 to identify the option that the mobile telephone 5 predicts the user is most likely to select. In such an embodiment, the mobile telephone 5 can automatically transmit the predicted option to the mobile portal server 21 as the selected option without outputting the option to the user. However, such an implementation is not preferred as it does not give the user the opportunity to correct the selected option. Therefore, in such an embodiment, the mobile telephone 5 preferably outputs the identified option to the user on the display 25, so that the user can either confirm the option via the keypad 27 or reject the option. If the user rejects the option then the mobile telephone 5 will display the predicted next most likely option until the desired option is selected by the users.

In the first embodiment described above, an internal log was maintained within the user's mobile telephone which recorded previous selections made by the user after reading previous barcodes. As those skilled in the art will appreciate, this internal log is effectively a user profile that records the usage pattern of the user. It will therefore be clear to those skilled in the art that other user profiles could be used instead of or in addition to the internal log. For example, the internal log of the first embodiment could be replaced by the user profile that is used in the second embodiment. The only difference is that more complicated algorithms have to be provided in the user's mobile telephone to process the received options in accordance with the user profile data in order to select one of the options or in order to rank the options.

In such an embodiment, the mobile portal server may transmit additional information associated with each option, when it transmits the plurality of options to the user device. The additional information may be used to facilitate the processing of those options using the stored user profile data. For example, the additional information may define a predicted type of user who will select the option. More specifically, the mobile portal server may identify, for each option, the type of user that is most like to select that option. The user's mobile device can then use the stored user profile data and this additional information to rank or to identify the most likely options that the user will select.

In such an embodiment where user profiling is performed to process the options received from the mobile portal server 21, some of the profiling calculations may be performed by the mobile portal server 21, in order to reduce the calculations performed by the user's mobile device. For example, the mobile portal server 21 may analyse the barcode tag value received from the user's mobile telephone to identify the class of product or service associated therewith. The mobile portal server 21 can then assign a proprietary code for that class of product which the mobile portal returns to the user's mobile telephone for storage in the internal log 57 together with the corresponding selected option. In this case, as there will be fewer classes of products than there are unique barcode tag values, the user profiling performed by the user's mobile telephone will be simplified.

In the first embodiment described above, after the user selects an option, the user's mobile telephone transmits data identifying the selected option and the barcode tag value to the mobile portal, which in turn retrieves and transmits an appropriate URL for content back to the user's mobile telephone. In an alternative embodiment, the mobile portal may be arranged to transmit the different URLs associated with the plurality of options when it transmits those options to the user's mobile telephone for selection. In this case, once an option has been selected, the user's mobile telephone would simply use the associated URL to retrieve the content associated with the selected option from the Internet.

In the second embodiment described above, a profile calculator 85 was provided in the user's mobile telephone 5 to calculate user profile data 83 for the user from user data 81 entered by the user and from the internal log 57 of previous barcode tag values and selected options. One of the aims of the second embodiment is to ensure that the confidential user data 81 is not provided to the remote mobile portal server 21. This aim can still be achieved even if some of the user profiling calculations performed by the profile calculator 85 are performed by the mobile portal server 21. In particular, the calculations using the internal log 57 may be performed by the mobile portal server 21. The resulting data can then be returned to the user's mobile telephone 5 for use in the algorithms defined by the profile calculator 85. This arrangement will reduce the amount of processing required by the profile calculator 85 and will therefore reduce the size of the profile calculator program that has to be stored in the user's mobile telephone 5. For example, the mobile portal server 21 may analyse the barcode tag value received from the mobile telephone to identify the class of product or service associated therewith. The mobile portal server 21 can then assign a proprietary code for that class of product which the mobile portal returns to the user's mobile telephone for storage in the internal log 57 together with the corresponding selected option. In this case, as there will be fewer classes of products than there are unique barcode tag values, the user profiling performed by the profile calculator 85 will be significantly simplified.

In the second embodiment described above, the user profile data received from the user's mobile telephone was used to categorise the user into one of a plurality of user types. Instead of such a strict categorisation, a more statistical approach may be taken. For example, all of the options for each user type may be stored in the tag database 23 together with a weighting identifying the predicted relevance of the option for that type of user. The received user profile data can then be used (with or without further processing) to determine a score or weighting for each user type. In other words, instead of classifying the user into one of the plurality of user types, the user is classified as belonging to each user type, but with a weighting that depends on how well the user profile agrees with that user type. The user type weightings thus determined can then be combined (e.g. by multiplication) with the weightings of the options stored in the tag database 23 associated with the corresponding user type. All of the weighted options thus obtain for the received barcode tag value can then be ranked based on the weightings associated with each option and the M options having the highest weighting can be selected for downloading to the user's mobile telephone 5. In the case where overlapping options appear within the tag value tables stored in the tag database 23, a bonus weighting may be applied which depends on the individual weightings associated with the overlapping options. As those skilled in the art will appreciate, various other techniques can be used to carry out a more statistical approach to identifying the options to be returned to the user's mobile telephone.

In the second embodiment described above, a user profile calculator was provided in the user mobile telephone and was updated from time to time as the mobile portal server 21 gathered knowledge about the use of the system by various users. In an alternative embodiment, the profile calculator within the user's mobile telephone is not updated. Instead, the mobile portal server 21 uses the determined correlations between the user profiles, selected options and barcode tag values to update the tag value database 23 and/or the options database 29.

In the second embodiment described above, the mobile portal 11 used user profiling techniques in a number of different ways to try to target the options and content for the user. As those skilled in the art will appreciate, simpler embodiments may be provided in which some of this user profiling is not performed. For example, in one embodiment, the mobile portal 11 may not store separate URLs for the different user types within the options database 29. Further, in the second embodiment, it is not essential that the mobile portal 11 uses style sheets to personalise the way in which the retrieved options are sent back to the user's mobile device. Instead, the retrieved options can simply be returned for output to the user in any convenient manner. Further, in the second embodiment, it is not essential for the user to return their user profile and the barcode tag value together with the selected option. In a simpler embodiment, when the user selects the desired option, the user's mobile device may be arranged to transmit only the option identifier for the selected option and the barcode tag value back to the mobile portal 11. In this case, the mobile portal 11 would not be able to statistically analyse the selected options and user profile data received from different users to update the data stored within the mobile portal 11 or the profile calculator within the user mobile devices.

In the second and third embodiments described above, the user profile data 83 calculated by the profile calculator 85 comprised a plurality of parameter values. As those skilled in the art will appreciate, there are various different types of user profile data that can be used. For example, instead of the one dimensional type of parameter values used in the above embodiments, multi-dimensional parameter values may be used. The different types of user profile data 83 that can be used will be apparent to those skilled in the art of user profiling.

In the second and third embodiments described above, when the options are received by the mobile telephone 5 from the mobile portal server 21, the options were output to the user without further processing. As those skilled in the art will appreciate, in the second and third embodiments, the type of processing carried out in the first embodiment may also be carried out in order to further process the options to rank them or to select the most appropriate option based on the user profile data or the internal log.

In the second and third embodiments described above, the mobile portal server 11 stored various options for each barcode and options were selected based on received user profile data. In an alternative embodiment, the mobile portal server 11 may transmit all of the options together with data associating the different options with different user types to the user mobile device, which compares the data associating the different options with different user types with the stored user profile data to select an option or to identify a relevant subset of the options for output to the user. In such an embodiment, the user device may be arranged to transmit information identifying the selected options back to the mobile portal server for use in updating the options that are stored and/or the data associating the different options with the different user types.

Three different types of systems were described above in the first three embodiments. As those skilled in the art will appreciate, a system may be implemented in which some users operate in accordance with the first embodiment whilst others operate in accordance with the second or third embodiments or in which some users operate in accordance with a combination of the first, second and/or third embodiments. In other words, only a subset of the users may be arranged to transmit their user profile data and the selected options back to the mobile portal server for user profile analysis etc.

In the third embodiment described above, the mobile portal server 11 downloads content into the user's mobile telephone for play out in response to the user subsequently reading a barcode associated with that content. This embodiment may be used to provide a system for rewarding users for maintaining brand loyalty. For example, if the user reads a barcode associated with a product of a particular brand owner, the server may download multimedia content (e.g. a film or a music file) provided by that brand owner. Access to this content would only be provided when the user buys another product of the brand owner. Access to the content can be controlled by encrypting the content and by embedding the encryption key to unlock the content within a barcode that is only provided to the user when the user purchases the other product. Alternatively, the encryption key to the unlock content may be provided by the mobile portal server in response to the user's mobile device transmitting the barcode tag value associated with the other product to the mobile portal server.

As those skilled in the art will appreciate, with such a system, a significant amount of data may be downloaded into the user's mobile telephone. It may, therefore, be necessary to seek the user's permission before downloading the content into the user's mobile telephone. Further, in view of the current charging policies for downloading content over the telephone network, the downloading of this content preferably happens over a wireless Internet connection between the user's mobile telephone and the mobile portal server 21. Such wireless Internet connections are becoming more and more widespread in public places, such as bars, stations, airports etc. Therefore, with a direct Internet connection between the user's mobile telephone and the mobile portal server 21, it becomes possible to download large files such as movies to the user's portable device with little or no cost to the user.

In the third embodiment described above, the same remote server was used to provide information about a current product as well as content relating to another related product. As those skilled in the art will appreciate, the content that is stored in the user's mobile device may be provided by any computer server. In other words, the downloading of content for storage in the user's device does not have to be linked to the reading of a barcode of a related product.

The third embodiment described above was based on the second embodiment. As those skilled in the art will appreciate, the modifications introduced by the third embodiment could also apply to other simpler embodiments. For example, in the third embodiment, it is not essential for the mobile portal 11 to use the user profile data to select the options to be returned to the user's mobile device. In a simpler embodiment, the selection of the options could be performed in a similar manner to the way in which they were selected in the first embodiment.

In the above embodiments, when the user selected an option the user's mobile telephone transmitted the option identifier for the selected option together with the barcode tag value back to the mobile portal server 21. This information was then used either to select an appropriate URL for the selected option or for user profiling calculations. As those skilled in the art will appreciate, it is not essential to retransmit information that has already been transmitted to the mobile portal server. For example, in the first embodiment, when the user selects an option, it is not essential to retransmit the barcode tag value, since the barcode tag value has already been transmitted to the mobile portal server.

However, the preferred embodiments do retransmit this information in order to avoid the mobile portal server having to keep track of the information that has already been received by each of the users.

In the above embodiments, the user's mobile telephone 5 included a barcode reader 7. As those skilled in the art will appreciate, the barcode 7 reader may be mounted in a separate device which is connected to an interface of the user's mobile telephone 5. Additionally, the barcode reader 7 can be any conventional type. For example, the barcode reader may be an optical barcode reader which scans a light beam across the barcode to be read or which reads the barcode when the barcode is moved across the reader 7. Alternatively, the barcode reader 7 could capture an image of the barcode and then determine the barcode tag value through suitable processing of the captured image. Additionally, as those skilled in the art will appreciate, it is not essential for the barcode to be a printed optical barcode. Instead, other barcode technologies, such as magnetic or capacitive barcode technologies could be used. Capacitive and magnetic barcode technologies offer the advantage that the barcode can be hidden from view and will not, therefore, detract from the appearance of the product.

Additionally, as those skilled in the art will appreciate, it is not essential for the barcode to be a one dimensional barcode. Two dimensional barcodes may be used which increases the data capacity that can be stored within the barcode. This may be useful in some applications where a limited amount of information relating to the product is encoded within the barcode and output to the user when the barcode is read.

In the above embodiment, the tag value associated with the product was generated from a machine readable code in the form of a barcode. As those skilled in the art will appreciate, the tag value associated with the product can be obtained from any machine readable code. For example, the tag value can be obtained from an RFID or other suitable transponder device (such as an electronic transponder or magnetostrictive device) that is associated with the product. However such an embodiment is not preferred because of the additional costs associated with such RFID tags and transponders.

In the above embodiment, the tag value obtained from the product related only to the product. In an alternative embodiment, the tag value may also include the web address of the mobile portal 11. In this case, it is not necessary for the user's mobile telephone 5 to store the web address of the mobile portal 11. However, such an embodiment is not preferred as it becomes difficult to update the information for a product after the barcode has been printed and attached to the product. If the web address of the mobile portal 11 is stored in the user's mobile telephone 5, then this can be updated as needed.

In the above embodiments, the mobile portal server 21 retrieved a URL for content from an options database 29. This URL identified the location of the content on a separate merchant website 12. As those skilled in the art will appreciate the URL may define a storage location within the mobile portal 11. Additionally, instead of the mobile portal 11 returning the URL for the content, it may simply retrieve the content itself using the URL and then return the content directly to the user's mobile telephone 5.

In the above embodiments, the user's mobile telephone 5 connected to the mobile portal 11 via the telephone network 15 and the Internet 17. As those skilled in the art will appreciate, the user's mobile telephone may connect directly to the mobile portal 11 via the telephone network without having to pass via the Internet 17.

In the above embodiments, the user used a mobile telephone 5 to obtain information about products or services. As those skilled in the art will appreciate, it is not essential to employ a mobile telephone. For example, the same functionality can be achieved using any portable electronic device, such as a personal digital assistant (PDA), laptop computer etc. In this case, the connection to the remote mobile portal server 21 may be achieved via a wireless network connecting the user's portable computer device and the mobile portal 11. Further, it is not essential that the mobile portal and the merchant server are located on the Internet. These servers may be provided on any computer network. In this case, the mobile portal 11 would not store the URL for the content, but instead would store the appropriate network address for the content.

In the above embodiments, the user's mobile telephone was arranged to output the options and the content to the user via the display 25. As those skilled in the art will appreciate, the options and/or the content may be output to the user in other ways, such as via an associated printer or via the loudspeaker 45. For example, a speech synthesiser may be provided within the user's mobile device which generates speech corresponding to the text of each option. The generated speech can then be output to the user via the loudspeaker 45. Similarly, the content that is received relating to the product may correspond to an audio file which is used to generate an audio signal which is output to the user again via the loudspeaker 45.

In a similar way, in the above embodiments, the user selected an option via the keypad of the user's mobile telephone 5. As those skilled in the art will appreciate, the user can select the option through any appropriate user interface. For example, the user may select the option through an appropriate voice command input via the microphone 47. In this case, an appropriate voice recognition module would be provided within the user's device for recognising the spoken selection.

In the above embodiments, the mobile portal 11 stored various different data within the tag database 23 and the options database 29. As those skilled in the art will appreciate, this data may be stored in these databases (or in a single database) in any conventional manner. The description of the data stored in these databases with reference to the above described tables is given for ease of understanding and for illustration only.

In the above embodiments, the mobile portal 11 downloaded a set of options in response to a barcode tag value received from the user's mobile device. In a preferred embodiment, the options include a request for further options so that if the user does not see the desired option they can request further options from the mobile portal 11. In this way, if the mobile portal 11 has selected a subset of the possible options using user profiling, the user can still access other options. As those skilled in the art will appreciate, such requests for other options are useful for updating the databases within the mobile portal 11 and for updating the user profile calculator stored in the user's mobile device.

A number of embodiments have been described above which employ a user device and one or more computer servers. As those skilled in the art will appreciate, the functionality of these devices may be provided by dedicated hardware circuits or by computer software run in conjunction with a programmable computer device. The software may be provided on any computer readable medium, such as floppy disk, CD-ROM, memory, carrier signal etc. The software may be provided in compiled or uncompiled form and may be in any language including microprocessor language. The software includes in its most general sense, computer implementable instructions for controlling a programmable computer device to carry out the required processing.

These and various other modifications and alternative embodiments will be apparent to those skilled in the art. The invention is not intended to be limited to the specific embodiments described above, which are given by way of example only.

1. A data transmission system comprising a user device and a computer server configured to communicate via a communications network;
wherein the user device comprises:
a reader configured to read a machine readable code that is associated with a product or service, to generate a corresponding tag value;
a tag value transmitter configured to transmit the tag value to said computer server;
wherein said computer server comprises:
a tag value receiver configured to receive the tag value from the user device;
an identifier configured to use the received tag value to identify a plurality of options relating to the product or service that are associated with the tag value; and
an options transmitter configured to transmit the identified options to said user device;
wherein said user device further comprises:
an options receiver configured to receive the plurality of options from said computer server;
a memory configured to store user profile data;
a processor configured to process the received options in dependence upon said user profile data to generate processed or options data; and
a requestor configured to request information relating to a selected option based on said processed options data.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A computer server comprising:
a tag value receiver configured to receive a tag value and a possible user profile data associated with a product or service from a user device;
an option identifier configured to use only the tag value to identify a plurality of options relating to the product or service that are associated with the tag value if the receiver received only the tag value, or
an option identifier configured to use both the tag value and the user profile data to identify a plurality of options relating to the product or service from a number of stored options if the receiver received both the tag value and the user profile data; and
an options identifier transmitter configured to transmit the identified options to said user device.

16. The computer server according to claim 15, further comprising:
an option data receiver configured to receive data indicative of a selected one of said plurality of options;
an address retriever configured to use said data indicative of the selected option to retrieve a network address for information relating to the selected option; and
an address transmitter configured to transmit the network address to the user device.

17. An apparatus comprising:
a reader configured to read a machine readable code that is associated with a product or service, to generate a corresponding tag value;
a memory configured to store user profile data for the user;
a tag value transmitter configured to transmit the tag value to a computer server;
an option receiver configured to receive plurality of options relating to the product or service that are associated with the tag value from said computer server and server; and
a requester configured to request information relating to a selected option based on said processed options data.

18. The apparatus according to claim 17, wherein said processor is operable to process the options received from said computer server using said user profile data to rank said options so that options the processor predicts the user is most likely to select are ranked higher than options that the processor predicts the user is less likely to select;
wherein the user device further comprises:
an outputter configured to output at least one said ranked options; and
a selection receiver configured to receive a user selection of one of the output options; and
wherein said requestor is operable to request information relating to the option selected by the user.

19. The apparatus according to claim 18, wherein said outputter is operable to output one or more of said ranked options on a display.

20. The apparatus according to claim 18, wherein said processor is operable to process the options using said user profile data to generate a ranked list of options and wherein said outputter is operable to output at least one said options in accordance with said ranked list of options.

21. The apparatus according to claim 17, wherein said processor is operable to process said plurality of options to select one of those options based on said user profile data and wherein said requestor is operable to request information relating to the option selected by said processor.

22. The apparatus according to claim 17, further comprising an address receiver configured to receive data indicative of a network address identifying the storage location of information relating to the selected option and wherein said requester is operable to request said information using said network address.

23. The apparatus according to claim 22, wherein said network address is a universal resource locator (URL) and wherein said requestor is operable to request said information from the Internet using said URL.

24. The apparatus according to claim 17, operable to communicate with said computer server over a communication link including a wireless link.

25. The apparatus according to claim 17, wherein said user profile data comprises data identifying previous selections of options received from the computer server.

26. The apparatus according to claim 25, wherein each option has an associated option identifier and wherein said user profile data comprises a count associated with each option identifier identifying the number of times that option has been selected previously.

27. (canceled)

28. (canceled)

29. The apparatus according to claim 17, further comprising an updater configured to update said user profile in accordance with the selected option.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A computer server comprising:
a receiver configured to receive a tag value that is associated with a product or service from a user device;
an identifier configured to use the received tag value to identify a plurality of options relating to the product or service from a number of stored options;
an options transmitter configured to transmit the identified options to said user device;
a selected options and profile transmitter configured to receive data identifying a selected option made by the user and user profile data from said user device;
an analyser configured to perform a statistical analysis on the selected options, user profile data and tag value data obtained from a plurality of user devices, to calculate an update for a user profile calculator of said user device; and
an update transmitter configured to transmit said update for said user profile calculator to said user device.

60. An apparatus comprising:
a reader configured to read a machine readable code that is associated with a product or service, to generate a corresponding tag value;
a tag value transmitter configured to transmit the tag value to a computer server;
an option receiver configured to receive a plurality of options from said computer server;
an outputter configured to output one or more of said options;
a user selection receiver configured to receive a user selection of one of the output options;
a requestor configured to request information relating to a selected one of said received options;
a memory configured to store personal data relating to the user;
a calculator configured to process said personal data to calculate generalised data representative of the personal data and operable to generate user profile data using said generalised data representative of the personal data and data representative of previous selections made by the user;
a selected options and profile transmitter configured to transmit data identifying the selected option to said computer server together with said user profile data and said tag value;
an update receiver configured to receive an update for said user profile calculator from said computer server; and
an updater configured to update said user profile calculator using said update.

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. A computer server comprising:
a tag value receiver configured to receive a tag value associated with a product or service from a user device;
an identifier configured to use the received tag value to identify information relevant to the product or service associated with the generated tag value;
an identified information transmitter configured to transmit the relevant identified information to said user device;
a content identifier configured to use said received tag value to identify content associated with another tag value; and
a content transmitter configured to transmit the identified content associated with the other tag value to said user device.

73. An apparatus comprising:
a reader configured to read a machine readable code that is associated with a product or service, to generate a corresponding tag value;
a memory configured to store content associated with a tag value;
a tag value determinator configured to determine if said generated tag value is associated with content stored in said memory;
a content outputter configured to output said content to said user, if the generated tag value is associated with content stored in said memory;
a generated tag value transmitter configured to transmit the generated tag value to said computer server if the generated tag value is not associated with content stored in said memory;
a content receiver configured to receive information relevant to the product or service associated with the generated tag value; and
an outputter configured to output information relevant to the product or service associated with the generated tag value.

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. A computer program product, stored on a computer readable medium and executable in a user device, for selecting information relating to a machine readable code on the base of user profile data, the computer program product comprising:
a computer program code section for generating a corresponding tag value from a read machine readable code that is associated with a product or a service to be transmitted to a computer server;
a computer program code section for receiving a plurality of options relating to the product or the service that are associated with the tag value as a response to transmitted tag value, for processing the received options in dependence upon a user profile data in a memory to generate processed options data; and
a computer program code section for requesting the information relating to a selected option based on said processed options data.

86. The apparatus according to claim 17, further comprising a processor configured to process the received options in dependence upon said user profile data to generate processed options data.
